(19) United States
(12) Patent Application Publication
(10) Pub. No.: US 2024/0129570 A1
(43) Pub. Date: Apr. 18, 2024

(54) AUTOMATED DEPLOYMENT OF MEDIA IN SCHEDULED CONTENT WINDOWS

(71) Applicant: DISNEY ENTERPRISES, INC., Burbank, CA (US)

(72) Inventors: Philip Guinard WHITE, Granada Hills, CA (US); Jin Soo KANG, Irvine, CA (US); Aaron Matthew MUELLER, DeLand, FL (US); Jason Scott YOUNG, Glendora, CA (US)

(21) Appl. No.: 18/486,295

(22) Filed: Oct. 13, 2023

Related U.S. Application Data
(60) Provisional application No. 63/379,846, filed on Oct. 17, 2022.

(51) Int. Cl. H04N 21/262

(52) U.S. Cl. CPC H04N 21/26275; H04N 21/26283

(57) ABSTRACT

A computer-implemented method for automating a content release comprising the steps of: determining a content release plan associated with a content release, wherein the content release plan includes a plurality of line items, wherein each line item identifies a content item to be released; parsing the plurality of line items included in the content release plan to build a deployment graph, wherein the deployment graph identifies a plurality of deployment tasks to be executed to complete the content release; executing the content release plan by performing the plurality of deployment tasks according to a schedule identified in the content release plan; and updating the content release plan based on one or more real-time statuses of the plurality of deployment tasks.

### CROSS-REFERENCE TO RELATED APPLICATIONS

This application claims priority benefit of United States Patent Application titled “AUTOMATED DEPLOYMENT OF MEDIA IN SCHEDULED CONTENT WINDOWS,” Ser. No. 63/379,846, filed Oct. 17, 2022. The subject matter of this related application is hereby incorporated herein by reference.

### BACKGROUND

### Field of the Various Embodiments

Embodiments of the present disclosure generally relate to techniques for automating the steps involved in a content release involving digital assets.

### Description of the Related Art

Content release by a large company or enterprise is often a highly planned and coordinated effort that involves many different individuals, teams, content sources, and dependencies. A content release could be, for example, releasing audio and/or visual media to consumers (e.g., theatrical, streaming, social media, etc.), textual content (e.g., web pages, web announcements, blog posts, news articles, etc.), social media announcements, consumer product releases, opening of sales or reservations (e.g., parks and resort offerings, event tickets, etc.), and/or the like. A content release is often scheduled for a specified time or time window. In some cases, the content is also scheduled for removal at another specified time or time window. However, if the content is not released or removed properly and on schedule (e.g., incorrect timing or execution) and a misstep occurs, then the failure can lead to customer dissatisfaction, failure to meet contractual obligations related to the content release, reputational harm, loss of revenue, and such.

Oftentimes, the different individuals and teams track and coordinate a content release using different calendars, project plans, and/or Gantt charts. Different people (e.g., responsible teams or team members) could release or activate the content at the scheduled time and report the release status to other people (e.g., managers), who then update the various calendars, project plans, and/or Gantt charts. However, because of the disparate parties and applications involved, errors often occur during the content release process. Errors include content being released at the incorrect time, dependencies being missed or released out of order, status reports becoming out of date or improperly tracked, information being revealed before its intended release date, and/or the like.

Some content platforms, such as content management systems (CMS), video platforms, social media platforms, and/or the like, allow a user to prepare content in advance and specify a date and time at which the prepared content becomes publicly accessible. For example, a CMS could allow a published article to go into a publicly viewable state at the specified date and time. As another example, a video platform could allow a video to be uploaded and processed in advance and release the video at the specified date and time.

One problem with using content platforms for managing releases is that content platforms cannot interoperate with the applications used to manage the content release (e.g., applications for managing various calendars, project plans, and/or Gantt charts), and using the content platforms to automatically release content does not resolve the problems with the overall process. For example, the scheduled date and time for a content platform could be incorrectly configured, or the status of the release could be entered improperly or fail to be updated in one or more of the various applications used to manage the content release.

As the foregoing illustrates, what is needed are techniques that allow the applications used to manage the content release to interoperate with the infrastructure used to manage the content release.

### SUMMARY

One embodiment of the present disclosure sets forth a computer-implemented method for automating a content release. The method includes determining a content release plan associated with a content release, wherein the content release plan includes a plurality of line items, wherein each line item identifies a content item to be released. The method further includes parsing the plurality of line items included in the content release plan to build a deployment graph, wherein the deployment graph identifies a plurality of deployment tasks to be executed to complete the content release. The method also includes executing the content release plan by performing the plurality of deployment tasks according to a schedule identified in the content release plan. The method also includes updating the content release plan based on one or more real-time statuses of the plurality of deployment tasks.

At least one technical advantage of the disclosed techniques relative to the prior art is that the disclosed techniques provide the ability for a deployment service to interoperate with the content release plan and its creators and contributors. The deployment service is enabled to receive plan information from a content release plan, perform the execution of the content release plan via a release platform, and use status received from the release platform to automatically update the content release plan and provide the content plan contributors with notification in the case of errors or required inputs. The techniques also provide the ability to simulate the execution of a content release plan, provide simultaneous execution of independent content release plans, and provide secure communications between components of the automated content deployment system.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a conceptual illustration of the automated content deployment system for the automated release of digital content according to a content release plan, according to one or more embodiments;

FIG. 2 is a block diagram of the automated content deployment system for the automated release of digital content, according to a content release plan according to one or more embodiments;

FIG. 3 is a block diagram of the example content release plan of FIG. 2. for specifying content items, schedule, and dependencies for release, according to one or more embodiments;

FIG. 4 is a block diagram of the example deployment service of FIG. 2. for the automated release of digital content, according to a content release plan according to one or more embodiments;

FIG. 5 is a block diagram of the example deployment graph of FIG. 3. Illustrating deployment task and associated structures for automating content release, according to one or more embodiments;

FIG. 6 is a conceptual illustration of an example deployment service of the automated content deployment system, according to one or more embodiments;

FIG. 7A is a conceptual illustration of a first representation of an example content release plan expressed as a Gantt Chart and provided as an input to the automated content deployment system, according to one or more embodiments;

FIG. 7B is a conceptual illustration of a second representation of an example content release plan expressed as a Gantt Chart showing the schedule and interdependencies of the line items, according to one or more embodiments;

FIG. 8 is a conceptual illustration of an example deployment graph built by the deployment service from a content release plan, according to one or more embodiments;

FIG. 9 is a conceptual illustration of a flowchart showing the steps of the automated content deployment system, according to one or more embodiments; and

FIG. 10 is a conceptual illustration of a block diagram showing the components of a computing system suitable to execute the orchestrator module of the automated content deployment system according to one or more embodiments.

### DETAILED DESCRIPTION

In the following description, numerous specific details are set forth to provide a more thorough understanding of the various embodiments. However, it will be apparent to one of skilled in the art that the inventive concepts may be practiced without one or more of these specific details.

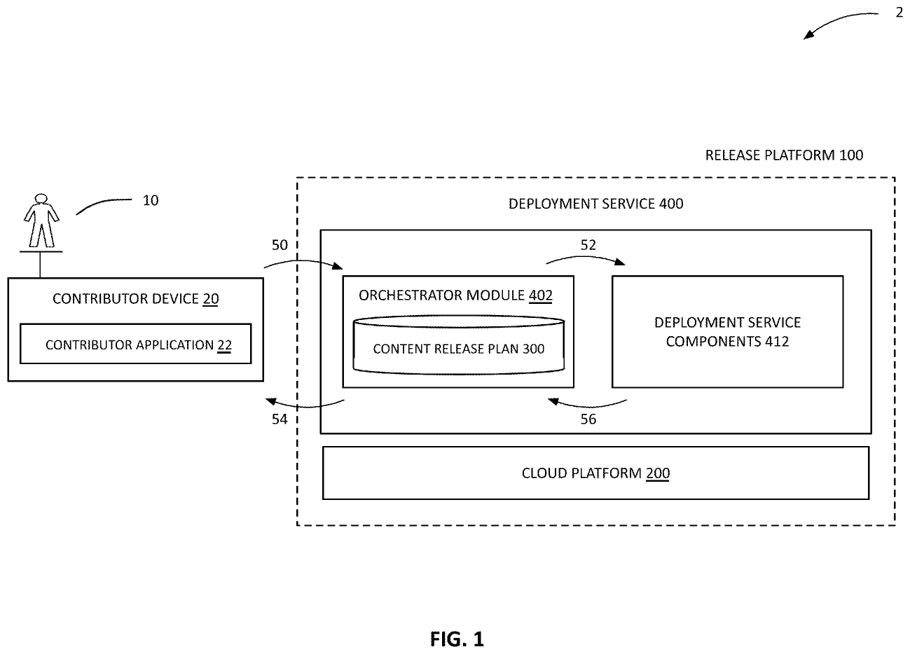

FIG. 1 is a conceptual illustration of the automated content deployment system 2 for the automated release of digital content according to a content release plan 300, according to one or more embodiments. The automated content deployment system 2 is comprised broadly of a release platform 100 and one or more contributors 10 that together construct the content release plan 300. The manipulation of the content release plan 300 occurs through a contributor application 22 executing on a contributor device 20. In some embodiments, the contributor application 22 is a browser. In some embodiments, the content release plan 300 takes the form of a spreadsheet or Gantt chart, and the contributor application 22 is specific to the form of the content release plan 300.

In some embodiments, such as when the content release plan 300 is constructed by a single contributor 10, the content release plan 300 is constructed on the contributor device 20 and imported at the release platform 100. In some embodiments, such as when the content release plan 300 is constructed by multiple contributors 10, the content release plan 300 is constructed on the release platform 100.

The release platform 100 includes the content release plan 300 and a deployment service 400. The deployment service 400 executes the content release plan 300 and deploys the content using the services of a cloud platform 200. The deployment service 400 includes an orchestrator module 402 and other deployment service components 412. Broadly speaking, the orchestrator module 402 is responsible for the importing, creating, viewing, editing, and persisting of the content release plan. The orchestrator module 402 also makes use of the other deployment service components 412 to realize the deployment of the content represented in the content release plan 300.

The content release plan 300, through the orchestrator module 402, serves as both an input 52 to and an output 56 from the other deployment service components 412. The other deployment service components 412 deploy the content according to the content release plan 300 and provide status updates and error reporting 56 to the content release plan 300 as the deployment proceeds. Likewise, the content release plan 300, through the orchestrator module 402, serves as both an output 50 from and an input 54 to the contributor device 20. One or more contributor devices 20 together construct 50 the content release plan 300, and as the deployment service 400 provides updates to the content release plan 300, those updates are forwarded to the one or more contributor devices 20.

Because of the flow of status reporting and error information 50, 52, 54, and 56, the contributor devices 20 are enabled by the release platform 100 to provide real-time information to the contributors 10 as the content release plan 300 is constructed and executed.

In some embodiments, the orchestrator module 402 can manage multiple content release plans 300, and the content release plans 300 can depend on other content release plans 300 such that one plan must finish before the next is initiated. In some embodiments, the orchestrator module 402 can manage multiple content release plans 300 such that content release plans 300 can be initiated and/or completed simultaneously.

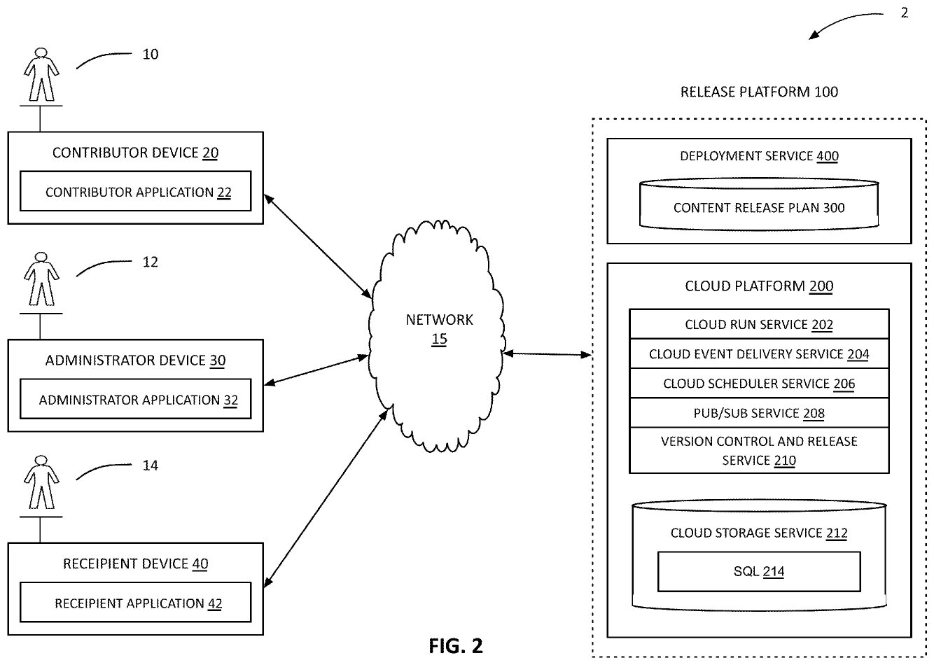

FIG. 2 is an expanded block diagram of the automated content deployment system 2 for the automated release of digital content according to a content release plan 300, according to one or more embodiments. In some embodiments, the release platform 100 employs a cloud platform 200 to store the content release plan 300 and execute the deployment service 400; however, the disclosed techniques are not limited thereto. The cloud platform 200 includes a cloud run service 202, cloud event delivery service 204, cloud scheduler service 206, publish and subscription service 208, version control and release system 210, and cloud storage service 212.

The deployment service 400 executes the orchestrator module 402 and the other deployment service components 412 using the cloud run service 202 to create the content release plan 300 and execute the plan according to the schedule set forth in the plan. As the content release plan 300 is being executed, status updates are transmitted for the updating of the content release plan 300. The cloud run service 202 is a “serverless” cloud computing environment that abstracts away the need for developers to provision or manage servers or backend infrastructure. Serverless computing, often referred to as Function as a Service (FaaS), is a cloud computing model that enables developers to focus solely on writing and deploying code, while the platform 200 automatically handles tasks such as provisioning, scaling, and load balancing. This approach allows for greater simplicity and efficiency as the server management or resource allocation tasks are handled in an automated fashion by the platform 200. Instead, the developers can concentrate on building applications and services that respond dynamically to incoming events or requests. Serverless platforms are designed to scale seamlessly based on demand, ensuring that the application remains available and responsive while also optimizing resource consumption and costs.

Certain communications, such as communications 50, 52, 54, and 56, between the various components of the release platform 100, contributor device 20, administrator device 30, and recipient device 40 are handled through the cloud event delivery service 204. The cloud event delivery service 204 is a fundamental component of cloud computing that enables the seamless transmission of events between different applications, services, and systems. The cloud event delivery service 204 provides a reliable and efficient way to propagate events, which can include changes in data, user actions, or other significant occurrences. The cloud event delivery service 204 ensures that when an event is triggered, the event is delivered to designated targets for processing or action. By using a standardized event format and well-defined triggers, the cloud event delivery service 204 enables decoupled and dynamic interactions between various components. Cloud event delivery is particularly valuable for building event-driven architectures, where applications can react in real-time to changing conditions or user inputs, enhancing overall system responsiveness and enabling a wide range of cloud-based workflows and applications.

The various modules and components of the deployment service 400, such as the orchestrator module 402 and the other deployment service components 412, are executed according to the schedule described in the content release plan 300 using the cloud scheduler service 206. The cloud scheduler service 206 enables users to automate and streamline the execution of tasks at specific intervals or designated times. With cloud scheduler service 206, users can schedule various types of activities, such as running scripts, invoking APIs, or triggering actions within their cloud infrastructure. Cloud scheduler services 206 offer the convenience of setting up automated workflows without manual intervention, which enhances efficiency and precision. Users can define schedules using time expressions, ensuring that tasks are executed precisely when needed. The cloud scheduler service 206 also often includes features like error handling and retry mechanisms, ensuring that tasks are reliable and resilient to failures. Advantageously, the cloud scheduler service 206 simplifies the orchestration of recurring tasks and enables users to optimize resource utilization and operational processes within their cloud environment.

Certain modules and components of the deployment service 400, such as the orchestrator module 402 and the other deployment service components 412, and different applications, such as the contributor application 22, administrator application 32, and recipient application 42, often need to follow different aspects of the deployment service 400 to perform their functions. The cloud publish & subscription service 208 facilitates seamless communication and interaction between different parts of applications and systems. The cloud publish & subscription service 208 serves as a messaging platform where messages are published to topics and then delivered to subscribers in a decoupled manner, enabling asynchronous communication and allowing components to exchange information without direct dependencies. Publishers generate messages, while subscribers receive and process those messages, enabling real-time data flow. The cloud publish & subscription services 208 versatility makes it suitable for various scenarios, including event-driven architectures, data processing, and interconnecting services which supports reliable message delivery, and its ability to handle high volumes of messages and subscribers makes it a key element in building scalable and responsive cloud-based solutions.

The code and data used to build the various modules and components of the deployment service 400, such as the orchestrator module 402 and the other deployment service components 412, are built and deployed using the cloud software version control and release system 210. The cloud software version control and release system 210 leverages cloud technology to provide a collaborative environment for teams to track changes and iterations of their codebase. Cloud software version control and release system 210 allows developers to work on different aspects of a project simultaneously, managing code versions, and facilitating seamless collaboration, which also includes mechanisms for code review, ensuring that changes meet quality standards before integration. The release aspect involves automating the deployment of software updates, ensuring consistent and efficient distribution across various environments. By utilizing cloud infrastructure, this approach provides scalability, accessibility, and real-time coordination, enabling teams to streamline their development, track changes, and deliver software updates more effectively.

The various modules and components of the deployment service 400, such as the orchestrator module 402 and the other deployment service components 412, need to persist data to perform their functions. Data is persisted using a cloud storage service 212. The cloud storage service 212 is an online platform that allows individuals and businesses to store their digital data securely and conveniently using standard SQL 214. Users can upload various types of files, such as documents, photos, videos, and more, to the cloud storage service's servers. These files are stored in virtual containers called “buckets” or “folders,” making it easy to organize and manage the data. Cloud storage services offer features like data encryption to ensure the privacy and security of the stored information. Users can access their files from anywhere with an internet connection, making it convenient for sharing and collaboration. The cloud storage service 212 serves as a reliable backup solution, as data is stored redundantly across multiple servers, reducing the risk of data loss. Overall, cloud storage services provide a flexible and scalable way to store, access, and manage digital content without the need for physical storage devices.

The automated content deployment system 2 includes several different user roles, including contributor 10, administrator 12, and content recipient 14. The administrator 12 is responsible for the setup and configuration of the release platform 100 using the administrator application 32 executing on the administrator device 30. In some embodiments, the administrator application 32 is a browser and the administration functionality is included in the cloud platform 200. The content recipient 14 interacts with the content released through the automated content deployment system 2 using the recipient application 42 executing on the recipient device 40. In some embodiments, the recipient application 42 is a browser. In some embodiments, the recipient application 42 is any application suitable to interact with the type of content being released through the automated content deployment system 2.

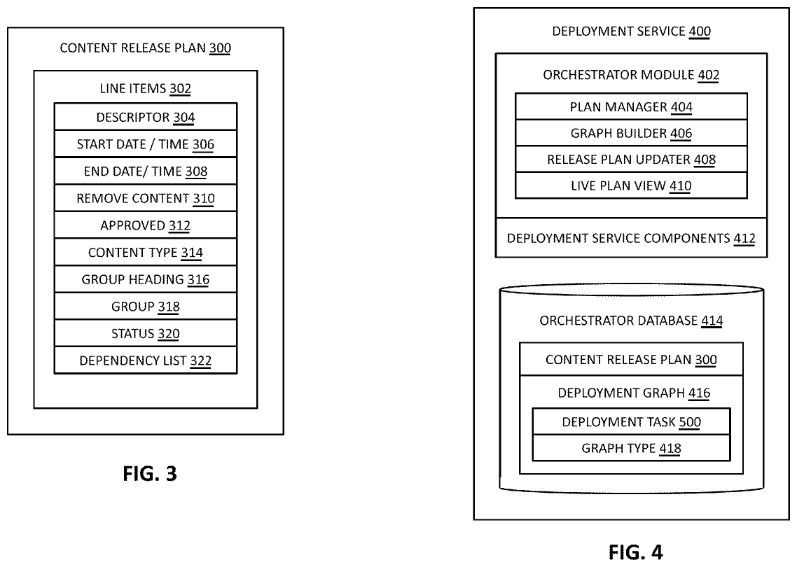

FIG. 3 is a block diagram of the example content release plan of FIG. 2. In some embodiments, a content release plan 300 includes a plurality of line items 302 (e.g., rows of a spreadsheet or task lines of a Gantt chart), where each line item 302 represents a different content item to be deployed. The line item 302 includes data describing the content item to be released. The descriptor 304 identifies the content to be released and includes a name, summary, associated resource location(s), and/or the like. The start date/time 306 and end date/time 308 identify, respectively, the date/time at which the content should be made available and the date/time at which the content should become unavailable. The remove content 310 Boolean indicates whether the content should be removed at the end of the content window (i.e. teardown). The approved 312 Boolean indicates whether the content item was approved for release. The content type 314 indicates what kind of content is slated for release (e.g., database update, service deployment, email, manual process, and/or the like). Group heading 316 indicates if the line item is a group heading. A group heading is used to organize multiple line items 302 into a group. In some embodiments, groups can be nested to provide additional organizational hierarchy. The group 318 element, when present, identifies the group heading 316 to which the line item 302 belongs. The status 320 identifies the current status of the line item. The status field values can include but are not limited to “NOT STARTED”, “DEPLOY STARTED”, “RELEASED”, “TEARDOWN STARTED”, and “REMOVED”. “NOT STARTED” indicates the deployment task has not started execution. “DEPLOY STARTED” indicates the deployment task has started execution. “RELEASED” indicates that a deployment task has finished but will not be removed. “TEARDOWN STARTED” indicates that the removal of a deployment task has started. “REMOVED” indicates that the removal of a deployment task has been completed. The dependency list 322 includes identifiers of line items (e.g., tasks in the same content release, tasks in a different content release included in the same project plan, tasks included in a different project plan, and/or the like) on which the line item depends, and/or the like.

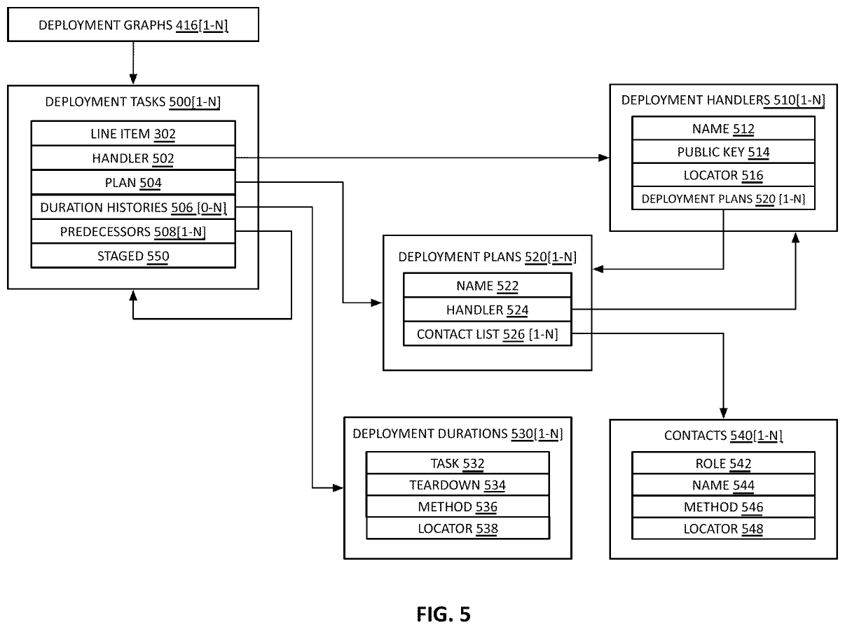

FIG. 4 is a block diagram of the example deployment service 400 of FIG. 2, according to one or more embodiments for the automated release of digital content according to a content release plan 300 according to one or more embodiments. The deployment service 400 executed by the cloud run service 202 on the cloud platform 200 includes an orchestrator module 402 which includes a plan manager 404, graph builder 406, release plan updater 408, and live plan view 410, all of which access data in the orchestrator database 414.

The plan manager 404 scans the contents of a content release plan 300 stored in the orchestrator database 414 and uses the graph builder 406 to instantiate the deployment graph 416 and constituent deployment tasks 500. The graph type 418 indicates whether the deployment graph 416 is intended for production or staging. The release plan updater 408 is responsible for persisting changes made to the content release plan 300. The change to the content release plan 300 can come from an edit made by contributor application 22. In another scenario, the change to the content release plan 300 can come from a status change or error condition reported by one of the other deployment service components 412, which is stored in status 320. In some embodiments, the release plan updater 408 is also responsible for updating changes to the visual representation of the GUI provided to the contributor application 22 by live plan view 410.

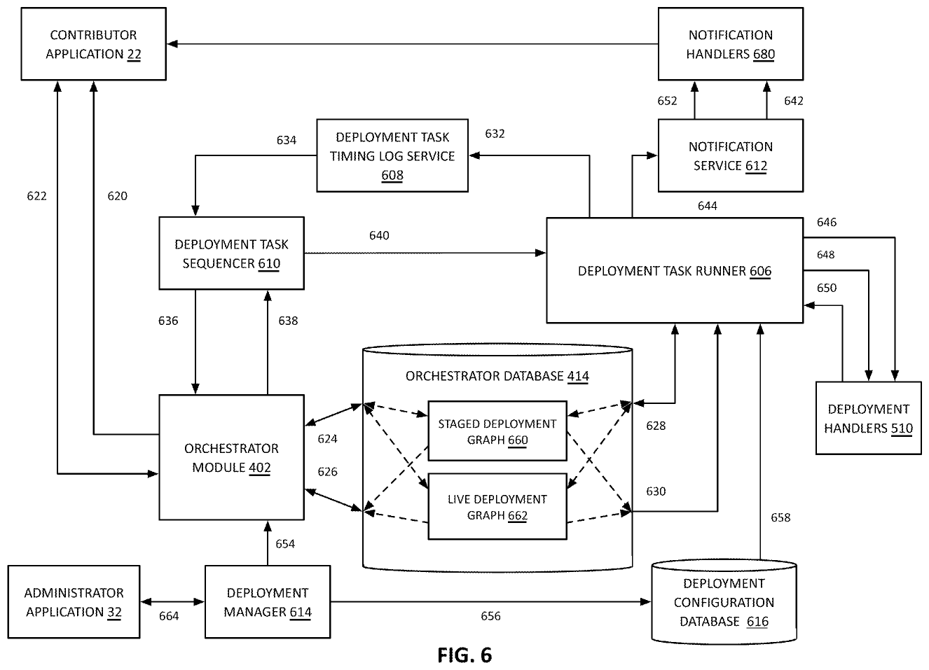

FIG. 5 is a block diagram of the example deployment graph of FIG. 3, according to one or more embodiments. Illustrating deployment tasks and associated structures for automating content release according to one or more embodiments. The deployment graph 416, built by the graph builder 406, includes one or more deployment tasks 500. Deployment tasks 500 are built based on line items 302 from the content release plan 300. In some embodiments, there is a one-to-one correspondence between line items 302 and deployment tasks 500, but the disclosure is not limited thereto. The deployment task 500 structure includes the elements of the line item 302 structure and adds additional fields including handler 502, plan 504, duration history 506, predecessors 508, and staged 550.

Handler 502 identifies one or more deployment handlers 510 responsible for executing one or more deployment plans 520 to deploy the content. The deployment handlers 510 can include but are not limited to a name 512, public key 514, locator 516, and one or more deployment plans 520. The name 512 is the alphanumeric name of the deployment handler 510 assigned to the deployment task 500. In some embodiments, the deployment handler 510 is assigned by the administrator 12. In some embodiments, the deployment handler 510 is assigned by the deployment service 400 based on the content type 314 of line item 302. The public key 514 is the public encryption key for the deployment handler 510.

Public-key encryption, also known as asymmetric encryption, is a cryptographic technique used to secure data communication. It involves a pair of mathematically related keys: a public key and a private key. In this system, the public key is made available to anyone who wishes to send an encrypted message to the key's owner. The private key, on the other hand, is kept secret and known only to the owner. When someone wants to send a secure message to the key's owner, they use the recipient's public key to encrypt the message. Once encrypted, only the owner of the corresponding private key can decrypt and read the message. This approach simplifies key distribution, as only the public key needs to be shared openly. It also enables digital signatures, which can be used to verify the authenticity and integrity of messages or files. Public-key encryption is widely used to secure online communications and transactions. The locator 516 includes address information enabling the deployment task 500 to link to the deployment handler 510 when stored in a different database. The deployment plan 520 identifies one or more deployment plans 520 to be executed by the deployment handler 510.

Plan 504 identifies one or more deployment plans 520 available for execution by a deployment handler 510 and can include but is not limited to a name 522, handler 524, and one or more contacts 540. The name 522 is the alphanumeric name of the deployment plan 520. The handler 524 identifies the deployment handler 510 used to execute the deployment plan 520. Contact list 526 identifies one or more contacts 540 that are messaged when a status or error message becomes available for delivery.

Duration histories 504 identifies one or more deployment duration 530 tables storing information identifying the timing characteristics for a deployment task 500 that has been executed previously and includes a task 532, teardown 534 flag, method 536, and locator 538. The task 532 identifies the deployment task 500 for which the information is stored. The teardown 534 flag indicates whether the deployment task 500 should be removed after execution. The method 536 identifies the deployment handler 510 used in the timed deployment. The locator 538 includes addressing information enabling other tables to link to the deployment duration 530 table.

The contacts 540 table can include but is not limited to one or more contacts and includes a role 542, name 544, method 546, and locator 548. The role 542 identifies the role played by the contact. Examples of roles include a contributor 10 or an administrator 12. The name 544 is the alphanumeric name of the contact 540. The method 546 identifies the message delivery mechanism used to deliver a status or error message. Examples include e-mail, text, app messaging, and incident reporting service. The locator 548 includes addressing information enabling other tables to link to the contacts 540 table.

The deployment handlers 510, deployment plans 520, and contacts 540 are stored in a deployment configuration database and edited by the administrator 12. The deployment graph 416, deployment task 500 and deployment duration 530 tables are persisted in the orchestrator database 414 and are built from the content release plan 300 and edited by contributors 10.

The staged 550 flag identifies whether a deployment task is part of a staged deployment graph or a production deployment graph.

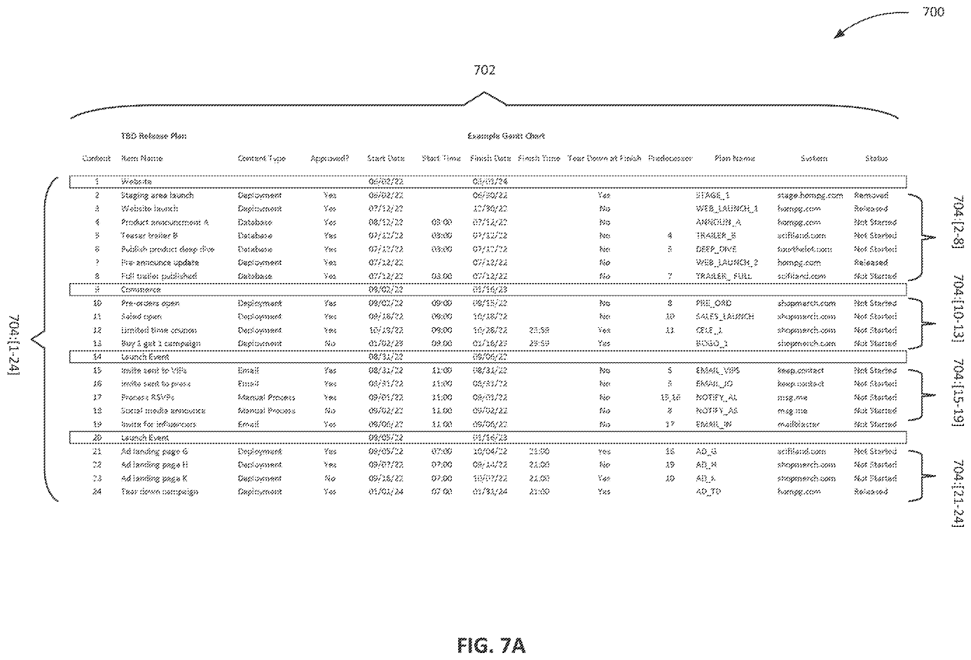

FIG. 6 is a conceptual illustration of an example deployment service 400 of the automated content deployment system 2, according to one or more embodiments. FIG. 6 shows in greater detail both the orchestrator module 402 and the various components that comprise the other deployment service components 412. The deployment service 400 uses the structures of FIG. 5 to persist the various data in orchestrator database 414 and deployment configuration database 616. The other deployment service components 412 include, inter alia, a deployment task runner 606, deployment task timing service 608, deployment sequencer 610, notification service 612, notification handlers 680, deployment handlers 510, and deployment manager 614. In some embodiments, the deployment handlers 510, and deployment manager 614 are external to the deployment service and provided by a third party.

The deployment service 400 begins with the orchestrator module 402 receiving instructions 622 from the contributor application 22 to create and edit the content release plan 300 persisted 624 in the orchestrator database 414. The orchestrator module 402 receives 626 status (and error) 320 updates whenever the status of the deployment graphs 416 changes. The status 320 updates are forwarded 626 from the orchestrator database 414 to the contributor application 22 through 620 the orchestrator module 402. The orchestrator database 414 stores distinct copies of the data for a staged deployment graph 660 and a live deployment graph 662. Changes in status and error state of the deployment graphs 416 (660 and 662) are reflected to the contributor application 22 through the live plan view 410. The live plan view 410 enables the contributor application 22 the ability to view both spreadsheet and Gantt chart views of the various deployment tasks 500 along with their statuses 320 in real-time as the schedule progresses.

Prior to the execution of scheduled deployment tasks 500 via the deployment task runner 606, the deployment tasks 500 are provisioned 664 through the deployment manager 614 using the administrator application 32. The deployment manager 614 has the responsibility of fulfilling deployment tasks 500 actions and is configured 656 in a deployment configuration database 616 with deployment plans 520 that enable 658 the deployment task runner 606 to locate and invoke deployment handlers 510. The deployment manager 614 provides a graphical user interface to enable administrators 12 via the administrator application 32 to provision, edit and view 664 deployment configurations and persist 556 them to the deployment configuration database 616.

A deployment task runner 606 is invoked periodically by a deployment task sequencer 610 to provide 640 the expected execution time to start upcoming tasks and optionally provides 640 an offset to the predicted deployment times which are computed 634 by a deployment task timing log service 608 based on historical deployment times 632 of the deployment task 500 based on previously rehearsed deployments recorded by the deployment task runner 606. Upon invocation, the deployment task sequencer 610 reports back 636 the initiation of the task back to the orchestrator module 402 which then persists 626 the status 320 back to the orchestrator database 414.

Stage deployments are rehearsed with a simulated and accelerated time rate 638 configurable 622 via the contributor application 22 through the orchestrator module 402 to enable testing and rehearsal of staged deployments without having to wait for the actual time duration between scheduled task deployments had the staged deployment been run at a normal rate.

As upcoming deployment tasks 500 are queued to run in the deployment task runner 606 by the deployment task sequencer 610, the deployment task 500 parameters and associated deployment plan 520 details are obtained respectively from 630 the orchestrator database 414 and from 658 deployment configuration database 616. The deployment task runner 606 is provided with a candidate list of deployment task 500 for execution. The deployment task runner 606 checks each of the deployment task 500 and removes deployment tasks 500 that are ineligible for execution from the candidate list to form a final list of deployment task 500 for execution. Conditions in a deployment task 500 in the candidate list that would cause the deployment task 500 to be removed include the deployment task's predecessors 508 having not yet successfully completed. Another reason includes the deployment task 500 having not been approved 312 for release. Another reason includes the deployment task having already started as indicated by the status 320 field. Another reason includes the computed start time for the deployment task 500 having not been reached. The computed deployment start time is estimated based on prior deployment times from the previous deployment duration 530 when available and computed based on the expected release time.

The remaining deployment tasks 500 are then initiated in parallel, and each corresponding status is marked with a “DEPLOY STARTED” status and updated 628 in the task database with the new status 320. To facilitate deployment, the detailed configuration and public key 514 for the task's deployment handler 510 is received 658 from the deployment configuration database 616 and combined 630 with the deployment task 500 parameters and deployment plan 520 to form an execution instruction message used to initiate deployment. The execution message, alongside a public key encrypted payload, is sent to the locator 516 of the deployment handler 510 which ultimately handles the deployment initiation request 646. These deployment handlers 510 are external to the deployment service 400. Each deployment handler 510 will ultimately reach an end state and report back a deployment result 650 of success or failure to the deployment task runner 606. The result status is persisted 628 back to the orchestrator database 414.

The status 320 change will be reflected in the live plan view 410 via the orchestrator module 402. The change in status 320 will also result in a notification event being sent 644 to a status notification service 612 which will notify the contacts 540 on record for the task 500 of the change in status 642 or/or the error condition 652. The notification handlers 680 can include email, text messaging, application messaging service, incident reporting service, and/or the like.

In the event of an error condition 652, the notification can additionally result in an incident being transmitted to an external incident reporting service so that the error can be addressed and resolved with greater immediacy.

Once a deployment task 500 has been completed, the deployment task 500 is now available for tear-down. As previously deployed deployment tasks 500 are queued for teardown by the deployment task runner 606 by the deployment task sequencer 610, the deployment task 500 parameters and associated deployment plan 520 details are obtained respectively from 630 the orchestrator database 414 and from 658 deployment configuration database 616.

The deployment task runner 606 is provided a list of previously deployed deployment tasks 500 for tear-down consideration. The deployment task runner 606 examines each of the deployment tasks 500 in the candidate list for various indicators to filter out ineligible deployment tasks 500 and form a subset of previously deployed deployment tasks 500 for teardown consideration. Conditions that would cause a deployment task 500 to be removed from tear-down consideration include the deployment task 500 not being enabled for tear-down. Another reason includes the deployment task tear-down having already started. Another reason includes the computed end time for the deployment task 500 having not been reached. The computed deployment start time is estimated based on prior tear down times when available and computed based on the expected content end time.

Tear-down for the subset of previously deployed deployment tasks 500 is then initiated, in parallel, and each deployment tasks 500 is marked with a “teardown started” status 320 and updated in the orchestrator database 414 with the new status 628. To facilitate deployment, the detailed configuration and public security key 514 for the deployment handler 510 is received 658 from the deployment configuration database 616 and combined with the deployment task parameters 630 and deployment plan 520 to form an execution instruction message used to initiate tear-down. The execution message, alongside a public key encrypted payload, is sent to the locator 516 of the assigned deployment handler 510 which ultimately handles the tear-down request 648. The deployment handlers 510 are external to the deployment service 400. Each deployment handler 510 will ultimately reach an end state change and report a tear-down result 650 of success or failure back to the deployment task runner 606. The result status is persisted 628 to the orchestrator database 414.

The status 320 change will be reflected in the live plan view 410 via the orchestrator 402. The change in status will also result in a notification event being sent 644 to a status notification service 612 for delivery to the contacts 540 listed for the deployment task as either an error 652 condition or status change 642. These notification handlers 680 can include email, text messaging, application messaging service, incident reporting service, or the like.

As with deployment initiation error handling, in the event of an error status, the notification can result in an incident being transmitted to an external incident reporting service so that the error condition can be addressed and resolved with greater immediacy.

Examples of deployment handlers 510 include a manual changer notifier which can be used to notify members of a social media team, a static website generator which can be used to refresh marketing landing pages, a toggle service which can be used to publish videos, a CMS update service which can be used to publish articles, a database update service which can be used to refresh product list, a search engine indexer which can be used to reindex product offerings, an AWS code deployer which can be used to deploy ticketing services, an Azure pipeline service which can be used to deploy marketing services, a Jenkins Cl/CD service which can be used to deploy data services, and a GitLab Cl/CD service which can be used to deploy sales services.

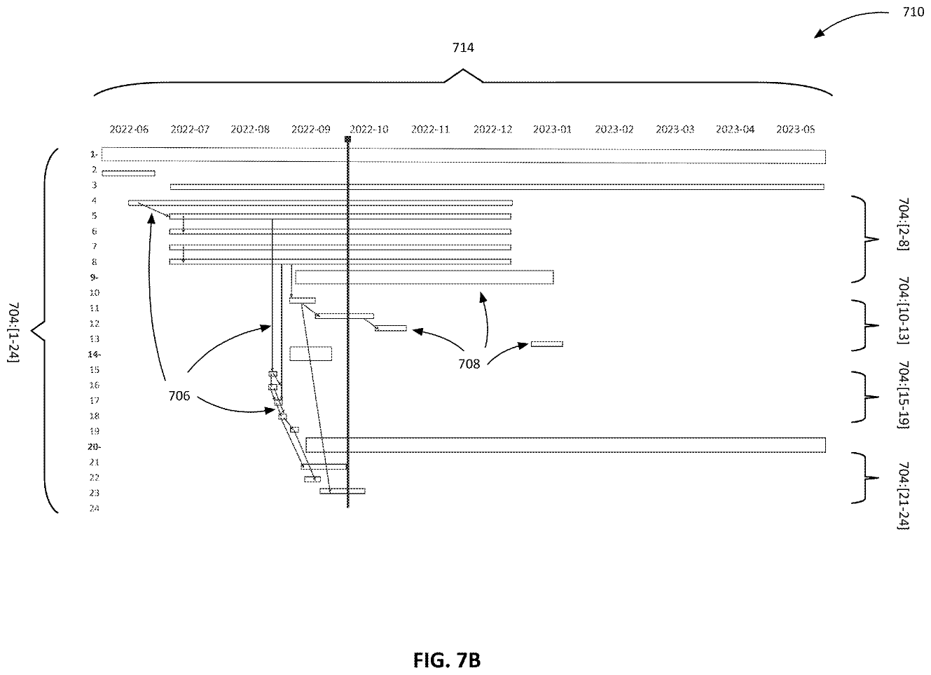

FIG. 7A is a conceptual illustration of a first representation of an example content release plan expressed as a spreadsheet to be provided as an input to the automated content deployment system, according to one or more embodiments. The content release plan 300 is shown in spreadsheet 700 form with the elements of the content release plan 300 shown as columns 702 and the values of the line items 302 in the content release plan 300 shown in rows 704. In this example, the content release plan 300 has twenty-four line items 704:[1-24]. Four of the lines items are group headings 704:[1, 9, 14, 20]. The four subgroups include 704:[2-8], 704:[10-13], 704:[15-19], and 704:[21-24].

As used herein, a spreadsheet 700 is a digital document used for organizing and manipulating data in a tabular format, often comprising rows and columns. Each cell within this grid can hold text, numbers, or formulas, allowing for data entry, calculations, and analysis. Spreadsheets are versatile tools for tasks like budgeting, data tracking, and creating graphs or charts. Popular spreadsheet software, like Microsoft Excel or Google Sheets, offers functions for data sorting, filtering, and visualization.

FIG. 7B is a conceptual illustration of a second representation of an example content release plan 300 expressed as a Gantt Chart according to one or more embodiments. The content release plan 300 is shown in Gantt Chart 710 form with the line items 302 shown along the vertical axis 704 and the schedule shown on the horizontal axis 714. Again, in this example, the content release plan 300 has twenty-four line items 704:[1-24] matching the line items 302 of the spreadsheet 700 view. Again, four of the line items are group headings 704:[1, 9, 14, 20]. The group heading lines items serve a special purpose in the Gantt Chart 710 view, showing the cumulative duration of the line items 302 included in the grouping.

As used herein, a Gantt chart is a graphical representation of a project schedule. It serves as a visual roadmap for managing and tracking tasks and activities within a project. In a Gantt chart, a horizontal timeline is used to represent the project's duration, with each task or activity depicted as a separate horizontal bar. These bars span the timeline, indicating when each task starts and ends.

One of the chart's strengths is its ability to display task dependencies. Arrows or lines connect 706 the bars 704 (which correspond to line items) to illustrate which tasks must be completed before others can begin, helping project managers and teams understand the order of operations. Gantt charts also show task durations 708, making it easy to assess how long each activity is expected to take. This feature aids in resource allocation, ensuring that team members are assigned to tasks efficiently. Furthermore, Gantt charts are invaluable for tracking progress. As deployment tasks 500 are completed, the tasks corresponding bars 704 are shaded or marked as finished, providing a clear visual representation of what has been accomplished. A vertical line showing the current time aids in determining a current position within the schedule. Gantt charts are indispensable tools for project planning, scheduling, and monitoring, enabling effective project management by promoting organization, collaboration, and a comprehensive understanding of project timelines and task interdependencies.

In some embodiments the spreadsheet can be used as the only representation of the content release plan 300 manipulated by the contributor application 22, however the present techniques are not limited thereto. In some embodiments the spreadsheet is used in combination with a Gantt Chart and forms part of the contributor application 22, however the present techniques are not limited thereto. The spreadsheet and Gantt Chart can be used in any combination and still fall within the scope of the present techniques. Likewise, any software embodiment operable to create a edit the information included in the content release plan falls within the scope of the present techniques.

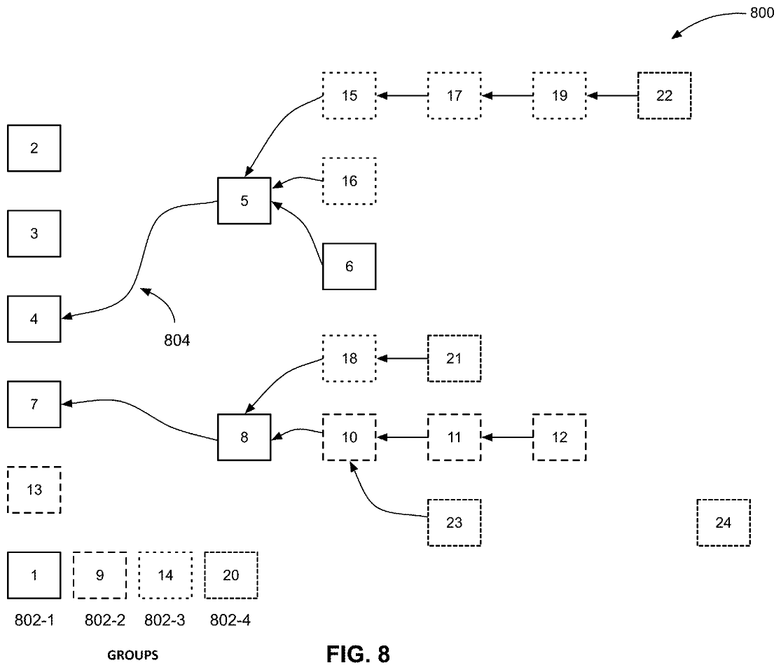

FIG. 8 is a conceptual illustration of an example deployment graph built by the deployment service from a content release plan according to one or more embodiments. The deployment graph diagram 800 illustrates the dependencies of a deployment graph 416 using the example data from FIG. 7A and FIG. 7B. The graph builder 406 of the deployment service 400, scans one or more content release plans 300 to build one or more deployment graphs 416. Each deployment graph 416 includes one or more deployment tasks 500. The example deployment graph 800 shows an “in memory” representation of the example spreadsheet 700 and spreadsheet 710, where the line items 704:[1-24] have been instantiated into deployment task 802:[1-24]. In the example of FIG. 8, the deployment graph diagram 800 includes four groups 802:[1-4], each shown with a different style hashed line. Group 802-1 includes lines items 704:[2-8], Group 802-2 includes lines items 704:[10-13], Group 802-3 includes lines items 704:[15-19], and Group 802-4 includes lines items 704:[21-24]. Dependency lines, such as dependency line 804, show that one deployment task 5 (from line item 5) depends on another deployment task 4 (from line item 4). That is, deployment task 4 must be completed before the start of deployment task 5 can begin. Likewise, deployment task 5 must be completed before the start of deployment task 6 can begin, and so on. A deployment task from one group can depend on a deployment task from another group, such as deployment task 18 (from group 802-3), depending on deployment task 8 (from group 802-1). A deployment graph is considered complete with all deployment tasks 500 from all groups have reached a completed status.

### Process Overview

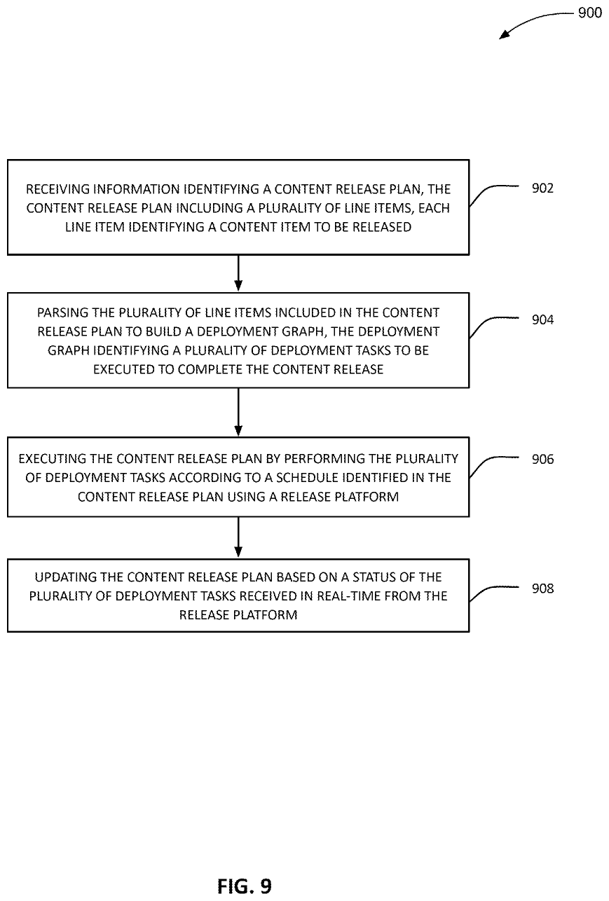

FIG. 9 is a flow diagram 900 of method steps for automating a content release according to various embodiments. Although the method steps are described in conjunction with the systems of FIGS. 1-8, persons of ordinary skill in the art will understand that any system configured to perform the method steps, in any order, is within the scope of the present disclosure.

As shown in FIG. 9, method 900 begins at step 902, where the deployment service 400 receives information identifying a content release plan 300, where the content release plan 300 includes a plurality of line items, and each line item 302 identifies a content item to be released. In some embodiments, the content release plan 300 can be created by a contributor device 20 and imported at the deployment service 400. In some embodiments, the content release plan 300 is created and edited at and on the deployment service 400. The line items 302 in the content release plan 300 describe the type of content 314 to be released, a method of deployment, and the dependencies 322 between the various line items 302 making up the content release plan 300.

At step 904, the deployment service 400 parses the plurality of line items included in the content release plan 300 to build a deployment graph 416, where the deployment graph 416 identifies a plurality of deployment tasks 500 to be executed to complete the content release. In some embodiments, the deployment graph 416 is instantiated by the orchestrator module 402 and stored in the orchestrator database 414. The deployment graph 416 is executed and updated by the other deployment service components 412. In some embodiments, both a staged deployment graph 660 and a live deployment graph 662 are instantiated.

At step 906, the deployment service 400 executes the content release plan 300 by performing the plurality of deployment tasks 500 according to a schedule identified in the content release plan 300 using a release platform 100. The schedule is determined from the content release plan 300, and exact start times are determined and refined by using the staged deployment graph 660 in conjunction with the deployment task timing log service 608, which estimates execution time based on past execution history. The life cycle of a deployment task 500 includes initializing the deployment task 500, periodically check the deployment task 500 for status and error conditions, terminating the deployment task 500 when complete, and optionally removing content deployed by the deployment task 500. In some embodiments, deployment tasks 500 are configured by an administrator 12, which assigns a deployment handler 510 and deployment plan 520 to a deployment task 500. In some embodiments, deployment tasks 500 are automatically configured by the orchestrator module 402, which assigns a deployment handler 510 and deployment plan 520 to a deployment task 500 based on content type 314. In some embodiments, a combination of both approaches is employed.

At step 908, the deployment service 400 updates the content release plan 300 based on a status 320 of the plurality of deployment tasks 500 received in real-time from the release platform 100. The release platform includes a cloud platform 200, which provides cloud event delivery services 204 and publish and subscribe services 208 used by the notification service 612 to deliver status reporting and error conditions. As a result, contributor 10 and administrator 12 are notified in real-time as the content release plan 300 is being executed is problems occur. Likewise, updates are provided by the other deployment service components 412 to the orchestrator module 402, which are used to the live plan view 410. As such, multiple contributors 10 are able to track the content deployment in real-time and share the same real-time view. The live plan view 410 can include a spreadsheet view 700, Gantt chart view 710, or both.

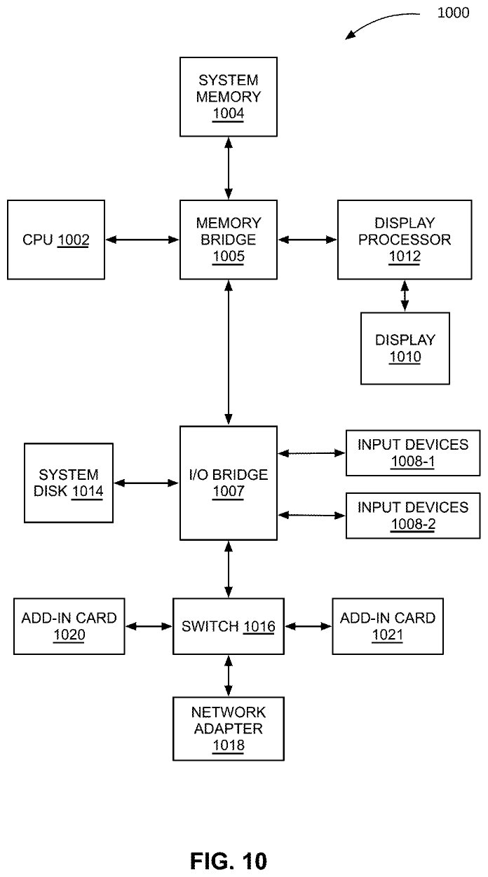

FIG. 10 depicts one architecture of a system 1000 within which embodiments of the present invention may be implemented. This figure in no way limits or is intended to limit the scope of the present invention. In various implementations, system 1000 may be an augmented reality, virtual reality, or mixed reality system or device, a personal computer, video game console, personal digital assistant, mobile phone, mobile device, server device, blade server, or any other device suitable for practicing one or more embodiments of the present invention.

As shown, system 1000 includes a central processing unit (CPU) 1002 and a system memory 1004 communicating via a bus path that may include a memory bridge 1005. CPU 1002 includes one or more processing cores, and, in operation, CPU 1002 is the master processor of system 1000, controlling and coordinating operations of other system components. System memory 1004 stores software applications and data for use by CPU 1002. CPU 1002 runs software applications and, optionally, an operating system. Memory bridge 1005, which may be, e.g., a Northbridge chip, is connected via a bus or other communication path (e.g., a HyperTransport link) to an input/output (I/O) bridge 1007. I/O bridge 1007, which may be, e.g., a Southbridge chip, receives user input from one or more user input devices 1008 (e.g., keyboard, mouse, joystick, digitizer tablets, touch pads, touch screens, still or video cameras, motion sensors, and/or microphones) and forwards the input to CPU 1002 via memory bridge 1005.

A display processor 1012 is coupled to memory bridge 1005 via a bus or other communication path (e.g., a PCI Express, Accelerated Graphics Port, or HyperTransport link). In one embodiment, display processor 1012 is a graphics subsystem that includes at least one graphics processing unit (GPU) and graphics memory. Graphics memory includes a display memory (e.g., a frame buffer) used for storing pixel data for each pixel of an output image. Graphics memory can be integrated in the same device as the GPU, connected as a separate device with the GPU, and/or implemented within system memory 1004.

Display processor 1012 periodically delivers pixels to a display device 1010 (e.g., a screen or conventional CRT, plasma, OLED, SED or LCD based monitor or television). Additionally, display processor 1012 may output pixels to film recorders adapted/configured to reproduce computer-generated images on photographic film. Display processor 1012 can provide display device 1010 with an analog or digital signal. In various embodiments, one or more of the various graphical user interfaces set forth in Appendices attached hereto, are displayed to one or more users via display device 1010, and the one or more users can input data into and receive visual output from those various graphical user interfaces.

A system disk 1014 is also connected to I/O bridge 1007 and may be configured to store content and applications and data for use by CPU 1002 and display processor 1012. System disk 1014 provides non-volatile storage for applications and data and may include fixed or removable hard disk drives, flash memory devices, and CD-ROM, DVD-ROM, Blu-ray, HD-DVD, or other magnetic, optical, or solid-state storage devices.

A switch 1016 provides connections between I/O bridge 1007 and other components such as a network adapter 1018 and various add-in cards 1020 and 1021. Network adapter 1018 allows system 1000 to communicate with other systems via an electronic communications network, and can include wired or wireless communication over local area networks and wide area networks such as the Internet.

Other components (not shown), including USB or other port connections, film recording devices, and the like, may also be connected to I/O bridge 1007. For example, an audio processor may be used to generate analog or digital audio output from instructions and/or data provided by CPU 1002, system memory 1004, or system disk 1014. Communication paths interconnecting the various components in FIG. 1 may be implemented using any suitable protocols, such as PCI (Peripheral Component Interconnect), PCI Express (PCIE), AGP (Accelerated Graphics Port), HyperTransport, or any other bus or point-to-point communication protocol(s), and connections between different devices may use different protocols, as is known in the art.

In one embodiment, display processor 1012 incorporates circuitry optimized for graphics and video processing, including, for example, video output circuitry, and constitutes a graphics processing unit (GPU). In another embodiment, display processor 1012 incorporates circuitry optimized for general purpose processing. In yet another embodiment, display processor 1012 may be integrated with one or more other system elements, such as the memory bridge 1005, CPU 1002, and I/O bridge 1007 to form a system on chip (SoC). In still further embodiments, display processor 1012 is omitted and software executed by CPU 1002 performs the functions of display processor 1012.

Pixel data can be provided to display processor 1012 directly from CPU 1002. In some embodiments of the present invention, instructions and/or data representing a scene are provided to a render farm or a set of server computers, each similar to system 1000, via network adapter 1018 or system disk 1014. The render farm generates one or more rendered images of the scene using the provided instructions and/or data. These rendered images may be stored on computer-readable media in a digital format and optionally returned to system 1000 for display. Similarly, stereo image pairs processed by display processor 1012 may be output to other systems for display, stored in system disk 1014, or stored on computer-readable media in a digital format.

Alternatively, CPU 1002 provides display processor 1012 with data and/or instructions defining the desired output images, from which display processor 1012 generates the pixel data of one or more output images, including characterizing and/or adjusting the offset between stereo image pairs. The data and/or instructions defining the desired output images can be stored in system memory 1004 or graphics memory within display processor 1012. In an embodiment, display processor 1012 includes 3D rendering capabilities for generating pixel data for output images from instructions and data defining the geometry, lighting shading, texturing, motion, and/or camera parameters for a scene. Display processor 1012 can further include one or more programmable execution units capable of executing shader programs, tone mapping programs, and the like.

Further, in other embodiments, CPU 1002 or display processor 1012 may be replaced with or supplemented by any technically feasible form of processing device configured to process data and execute program code. Such a processing device could be, for example, a central processing unit (CPU), a graphics processing unit (GPU), an application-specific integrated circuit (ASIC), a field-programmable gate array (FPGA), and so forth. In various embodiments any of the operations and/or functions described herein can be performed by CPU 1002, display processor 1012, or one or more other processing devices or any combination of these different processors.

CPU 1002, render farm, and/or display processor 1012 can employ any surface or volume rendering technique known in the art to create one or more rendered images from the provided data and instructions, including rasterization, scanline rendering REYES or micro-polygon rendering, ray casting, ray tracing, neural rendering, image-based rendering techniques, and/or combinations of these and any other rendering or image processing techniques known in the art.

In other contemplated embodiments, system 1000 may be a robot or robotic device and may include CPU 1002 and/or other processing units or devices and system memory 1004. In such embodiments, system 1000 may or may not include other elements shown in FIG. 1. System memory 1004 and/or other memory units or devices in system 1000 may include instructions that, when executed, cause the robot or robotic device represented by system 1000 to perform one or more operations, steps, tasks, or the like.

It will be appreciated that the system shown herein is illustrative and that variations and modifications are possible. The connection topology, including the number and arrangement of bridges, may be modified as desired. For instance, in some embodiments, system memory 1004 is connected to CPU 1002 directly rather than through a bridge, and other devices communicate with system memory 1004 via memory bridge 1005 and CPU 1002. In other alternative topologies display processor 1012 is connected to I/O bridge 1007 or directly to CPU 1002, rather than to memory bridge 1005. In still other embodiments, I/O bridge 1007 and memory bridge 1005 might be integrated into a single chip. The particular components shown herein are optional; for instance, any number of add-in cards or peripheral devices might be supported. In some embodiments, switch 1016 is eliminated, and network adapter 1018 and add-in cards 1020, 1021 connect directly to I/O bridge 1007.

In some embodiments, the contributor device 20, administrator device 30, recipient device 40 and servers employed in the implementation of release platform 100 are instances of system 1000.

In sum, techniques are disclosed for the automated release of content via an automated content deployment system. A content release plan that is created by one or more contributors via a deployment service identifies content through one or more line items. The line items identify content to be released, dependencies between line items, a source of the content, a destination for the content, and a time window during which the content will be available. The directory service is implemented using a cloud platform that provides underlying services to the directory service. The creation and management of the content release plan is realized through an orchestrator module that in turn, completes the content deployment through other deployment service components. The orchestrator module prepares the content release plan for execution by creating a deployment graph that includes a deployment task for each line item. The deployment task accomplishes the release of the content through deployment handlers that operate based on deployment plans. The orchestrator module can simulate the content release through a staged deployment graph to determine timing characteristics and ensure proper configuration of the deployment plans. As the content release plan is created, maintained, simulated, and executed, status and error conditions are both reflected in a live plan view and transmitted to contributors and/or administrators such that all stakeholders are informed in real-time and enabled to make corrections to the plan and configuration as needed. The directory service is enabled to execute multiple content release plans simultaneously and synchronously. Communications between the directory service and external deployment handlers are secured through the use of public key encryption.

At least one technical advantage of the disclosed techniques relative to the prior art is that the disclosed techniques provide the ability for a deployment service to interoperate with the content release plan and its creators and contributors. The deployment service is enabled to receive plan information from a content release plan, perform the execution of the content release plan via a release platform, and use status received from the release platform to automatically update the content release plan and provide the content plan contributors with notification in the case of errors or required inputs. The techniques also provide the ability to simulate the execution of a content release plan, provide simultaneous execution of independent content release plans, and provide secure communications between components of the automated content deployment system.

1. In some embodiments, a computer-implemented method for automating a content release comprises: determining a content release plan associated with a content release, wherein the content release plan includes a plurality of line items, wherein each line item identifies a content item to be released; parsing the plurality of line items included in the content release plan to build a deployment graph, wherein the deployment graph identifies a plurality of deployment tasks to be executed to complete the content release; executing the content release plan by performing the plurality of deployment tasks according to a schedule identified in the content release plan; and updating the content release plan based on one or more real-time statuses of the plurality of deployment tasks.

2. The method of clause 1 wherein the content release plan represents a directed graph that expresses dependencies and flow direction between content sources, content destinations, and the line items in the content release plan.

3. The method of clauses 1 or 2 wherein the line items include one or more of: a descriptor, start time, end time, removal flag, content type, release plan, release plan name, and status.

4. The method of any of clauses 1-3 wherein parsing the line items comprises: building the deployment graph that includes deployment tasks to be used to execute the content release plan.

5. The method of any of clauses 1-4 wherein executing the content release plan by performing the plurality of deployment tasks comprises: determining based on a current time and the schedule that a deployment task is ready for execution; and in response to determining that the deployment task is ready for execution, executing a deployment handler.

6. The method of any of clauses 1-5 wherein executing the deployment handler includes one or more of: initiating the deployment task, determining a status of the deployment task, and terminating the deployment task.

7. The method of any of clauses 1-6 wherein initiating the deployment task comprises: making the content item identified in a line item available via a release platform.

8. The method of any of clauses 1-7 wherein determining the status of the deployment task comprises: determining the status of an automation comprising one or more of: communicating with a release platform to determine if the content item previously made available via the release platform is accessible; and communicating with the release platform to determine if the content item previously removed via the release platform is not accessible.

9. The method of any of clauses 1-8 wherein terminating the deployment task comprises: removing a content item identified in a line item previously made available via a release platform.

10. The method of any of clauses 1-9 wherein the executing of the deployment handler includes one or more of: initiating a deployment task simulation, determining the status of the deployment task simulation, and terminating the deployment task simulation.

11. In some embodiments, one or more non-transitory computer-readable media storing instructions that, when executed by one or more processors, cause the one or more processors to perform the steps of: determining a content release plan associated with a content release, wherein the content release plan includes a plurality of line items, wherein each line item identifies a content item to be released; parsing the plurality of line items included in the content release plan to build a deployment graph, wherein the deployment graph identifies a plurality of deployment tasks to be executed to complete the content release; executing the content release plan by performing the plurality of deployment tasks according to a schedule identified in the content release plan; and updating the content release plan based on one or more real-time statuses of the plurality of deployment tasks.

12. The one more non-transitory computer-readable media of clause 11, wherein executing the content release plan by performing the plurality of deployment tasks comprises: determining based on a current time and the schedule that a deployment task is ready for execution; and in response to determining that the deployment task is ready for execution, executing a deployment handler.

13. The one more non-transitory computer-readable media of clauses 11 or 12, wherein executing the deployment handler includes one or more of: initiating the deployment task, determining a status of the deployment task, and terminating the deployment task.

14. The one more non-transitory computer-readable media of any of clauses 11-13, wherein initiating the deployment task comprises: making the content item identified in a line item available via a release platform.

15. The one more non-transitory computer-readable media of any of clauses 11-14, wherein determining the status of the deployment task comprises: determining the status of an automation comprising one or more of: communicating with a release platform to determine if the content item previously made available via the release platform is accessible; and communicating with the release platform to determine if the content item previously removed via the release platform is not accessible.

16. The one more non-transitory computer-readable media of any of clauses 11-15, wherein terminating the deployment task comprises: removing a content item identified in a line item previously made available via a release platform.

17. The one more non-transitory computer-readable media of any of clauses 11-16, wherein executing the deployment handler includes storing information identifying the deployment task performed in an audit log.

18. The one more non-transitory computer-readable media of any of clauses 11-17, wherein the content release plan is one of a plurality of content release plans; and the plurality of content release plans are released simultaneously.

19. The one more non-transitory computer-readable media of any of clauses 11-18, wherein releasing the plurality of content release plans includes determining an amount of time needed to execute each of the plurality of content release plans and starting each of the plurality of content release plans at different times for simultaneous completion of the plurality of content release plans.

20. In some embodiments, a system comprising: a memory storing an orchestrator module; and a processor coupled to the memory that executes the orchestrator module to perform the steps of: determining a content release plan associated with a content release, wherein the content release plan includes a plurality of line items, wherein each line item identifies a content item to be released; parsing the plurality of line items included in the content release plan to build a deployment graph, wherein the deployment graph identifies a plurality of deployment tasks to be executed to complete the content release; executing the content release plan by performing the plurality of deployment tasks according to a schedule identified in the content release plan; and updating the content release plan based on one or more real-time statuses of the plurality of deployment tasks.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for automating a content release comprising the steps of:
determining a content release plan associated with a content release, wherein the content release plan includes a plurality of line items, wherein each line item identifies a content item to be released;
parsing the plurality of line items included in the content release plan to build a deployment graph, wherein the deployment graph identifies a plurality of deployment tasks to be executed to complete the content release;
executing the content release plan by performing the plurality of deployment tasks according to a schedule identified in the content release plan; and
updating the content release plan based on one or more real-time statuses of the plurality of deployment tasks.

2. The method of claim 1, wherein the content release plan represents a directed graph that expresses dependencies and flow direction between content sources, content destinations, and the line items in the content release plan.

3. The method of claim 2, wherein the line items include one or more of: a descriptor, start time, end time, removal flag, content type, release plan, release plan name, and status.

4. The method of claim 1, wherein parsing the line items comprises:
building the deployment graph that includes deployment tasks to be used to execute the content release plan.

5. The method of claim 1, wherein executing the content release plan by performing the plurality of deployment tasks comprises:
determining based on a current time and the schedule that a deployment task is ready for execution; and
in response to determining that the deployment task is ready for execution, executing a deployment handler.

6. The method of claim 5, wherein executing the deployment handler includes one or more of:
initiating the deployment task,
determining a status of the deployment task, and
terminating the deployment task.

7. The method of claim 6, wherein initiating the deployment task comprises:
making the content item identified in a line item available via a release platform.

8. The method of claim 6, wherein determining the status of the deployment task comprises:
determining the status of an automation comprising one or more of:
communicating with a release platform to determine if the content item previously made available via the release platform is accessible; and
communicating with the release platform to determine if the content item previously removed via the release platform is not accessible.

9. The method of claim 6, wherein terminating the deployment task comprises:
removing a content item identified in a line item previously made available via a release platform.

10. The method of claim 6, wherein the executing of the deployment handler includes one or more of:
initiating a deployment task simulation,
determining the status of the deployment task simulation, and
terminating the deployment task simulation.

11. One or more non-transitory computer-readable media storing instructions that, when executed by one or more processors, cause the one or more processors to perform the steps of:
determining a content release plan associated with a content release, wherein the content release plan includes a plurality of line items, wherein each line item identifies a content item to be released;
parsing the plurality of line items included in the content release plan to build a deployment graph, wherein the deployment graph identifies a plurality of deployment tasks to be executed to complete the content release;
executing the content release plan by performing the plurality of deployment tasks according to a schedule identified in the content release plan; and
updating the content release plan based on one or more real-time statuses of the plurality of deployment tasks.

12. The one more non-transitory computer-readable media of claim 11, wherein executing the content release plan by performing the plurality of deployment tasks comprises:
determining based on a current time and the schedule that a deployment task is ready for execution; and
in response to determining that the deployment task is ready for execution, executing a deployment handler.

13. The one more non-transitory computer-readable media of claim 12, wherein executing the deployment handler includes one or more of:
initiating the deployment task,
determining a status of the deployment task, and
terminating the deployment task.

14. The one more non-transitory computer-readable media of claim 13, wherein initiating the deployment task comprises:
making the content item identified in a line item available via a release platform.

15. The one more non-transitory computer-readable media of claim 13, wherein determining the status of the deployment task comprises:
determining the status of an automation comprising one or more of:
communicating with a release platform to determine if the content item previously made available via the release platform is accessible; and
communicating with the release platform to determine if the content item previously removed via the release platform is not accessible.

16. The one more non-transitory computer-readable media of claim 13, wherein terminating the deployment task comprises:
removing a content item identified in a line item previously made available via a release platform.

17. The one more non-transitory computer-readable media of claim 12, wherein executing the deployment handler includes storing information identifying the deployment task performed in an audit log.

18. The one more non-transitory computer-readable media of claim 11, wherein the content release plan is one of a plurality of content release plans; and the plurality of content release plans are released simultaneously.

19. The one more non-transitory computer-readable media of claim 18, wherein releasing the plurality of content release plans includes determining an amount of time needed to execute each of the plurality of content release plans and starting each of the plurality of content release plans at different times for simultaneous completion of the plurality of content release plans.

20. A system comprising:
a memory storing an orchestrator module; and
a processor coupled to the memory that executes the orchestrator module to perform the steps of:
determining a content release plan associated with a content release, wherein the content release plan includes a plurality of line items, wherein each line item identifies a content item to be released;
parsing the plurality of line items included in the content release plan to build a deployment graph, wherein the deployment graph identifies a plurality of deployment tasks to be executed to complete the content release;
executing the content release plan by performing the plurality of deployment tasks according to a schedule identified in the content release plan; and
updating the content release plan based on one or more real-time statuses of the plurality of deployment tasks.
